(19) United States
(12) Patent Application Publication
(10) Pub. No.: US 2003/0233905 A1
(43) Pub. Date: Dec. 25, 2003

(54) Vibration resistive steering wheel and method

(76) Inventors: William E. Bostick, St. Clair, MI (US); William B. Cox JR., Berkley, MI (US); Michael A. Halifax, Fort Gratiot, MI (US); Anderson G. Lowrie, Port Huron, MI (US)

Correspondence Address: Laurence C. Begin, Dinnin & Dunn, P.C., 755 West Big Beaver Road, Troy, MI, 48084, US

(21) Appl. No.: 10/223,137

(22) Filed: Aug. 19, 2002

Related U.S. Application Data
(60) Provisional application No. 60/390,076, filed on Jun. 20, 2002.

(51) Int. Cl. B62D 1/04

(52) U.S. Cl. 74/552

(57) ABSTRACT

A steering wheel (10) for a motor vehicle includes a core member with a circular rim (12). At least one dampening element (14) is attached to the rim (12), preferably in a channel (11), the dampening element (14) having a density greater than the density of the core material, and preferably positioned substantially radially symmetrically around the rim (12). A method of manufacturing the steering wheel (10) is also provided, the method including steps of providing a steering wheel core member (12) having a circular rim section (12) with a channel (11), positioning at least one dampening element (14) in the channel (11), and delivering a flowable curable material around the rim section 12 to secure the dampening element therein.

### CROSS-REFERENCE TO RELATED APPLICATIONS

This Application claims the benefit of the filing date of Provisional Application No. 60/390,076, filed Jun. 20, 2002, and herein incorporated by reference.

### TECHNICAL FIELD

The present invention relates generally to steering wheels and vehicle steering assemblies, and more particularly to a steering wheel or steering assembly having increased resistivity to rotational vibration.

### BACKGROUND OF THE INVENTION

A longtime goal of automotive designers has been minimizing vibration in various vehicle systems during operation. Reductions in vibration can offer the advantages of less wear and tear on vehicle parts and higher operating efficiency due to less energy wasted by vibrating components, as well as greater comfort for the operator. Because structural and functional details of automobiles differ greatly among different vehicle lines and models, vibration suppression criteria for one vehicle may differ from that of other vehicles. Moreover, vibrational characteristics change when new system or structural technologies, and even new styling designs are incorporated into existing vehicle models.

Of particular interest to designers has been the development of vibration dampeners in vehicle steering wheels. Lessening vibrations communicated through the steering system can reduce operator fatigue and vehicle noise, and enhance overall driving enjoyment. Some methods of reducing vibration in the steering system have focused on the use of damper weights to absorb vibrations communicated through the steering column, and various methods are known in the art. In one approach, resilient members are used to join an airbag module to the steering wheel, thereby allowing the airbag module to act as a mass damper. In this approach, however, such systems require a relatively heavy airbag module to effectively suppress rotational vibrations. Other systems utilize a mass damper directly associated with the steering column. Again, such systems are relatively complex and require a relatively large mass.

### SUMMARY OF THE INVENTION

In one aspect, a steering wheel for a motor vehicle is provided. The steering wheel includes a core member having a central mount portion and a plurality of spokes connecting the mount portion with a substantially circular rim. At least one dampening element is secured to the rim, wherein the dampening element is formed from a material having a density greater than a density of the core member, and is secured in vibrational communication with the core member.

In another aspect, a method of manufacturing a steering wheel is provided. The method includes the steps of providing a steering wheel core member having a circular rim section with a channel, and positioning at least one dampening element in the channel, the dampening element having a density greater than the core member. The method further includes the steps of positioning the core member and dampening element in a molding apparatus, and delivering a flowable curable material into the molding apparatus, wherein the cured material adheres to the dampening element and the core member, and secures the dampening element in vibrational communication with the core member.

In still another aspect, a steering wheel is provided, the steering wheel being manufactured by a method including the steps of providing a steering wheel core member having a circular rim section with a channel, and positioning at least one dampening element in the channel, the dampening element having a density greater than the core member. The method further includes the steps of positioning the core member and dampening element in a molding apparatus, and delivering a flowable curable material into the molding apparatus, wherein the cured material adheres to the dampening element and the core member, and secures the dampening element in vibrational communication with the core member.

In still another aspect, a method of optimizing rotational vibration in a vehicle steering wheel is provided. The method includes the steps of forming a steering wheel core member having a substantially circular rim portion, the core member being connectable to a vehicle steering system, and attaching mass to the core member by providing at least one dampening element, and securing it about the rim portion, the dampening element preferably being positioned in substantial radial symmetry about the core member and having a density greater than the density of the core member.

### BRIEF DESCRIPTION OF THE DRAWINGS

FIG. 1 is a partial cross-sectional view of a steering wheel according to a preferred constructed embodiment of the present invention;

FIG. 2 is a partial elevational view of a steering wheel according to a preferred constructed embodiment of the present invention similar to FIG. 1;

FIG. 3 is a partial cross-sectional view of a steering wheel according to a second preferred embodiment of the present invention;

FIG. 4 is a partial cross-sectional view of a steering wheel according to a third preferred embodiment of the present invention.

### DETAILED DESCRIPTION

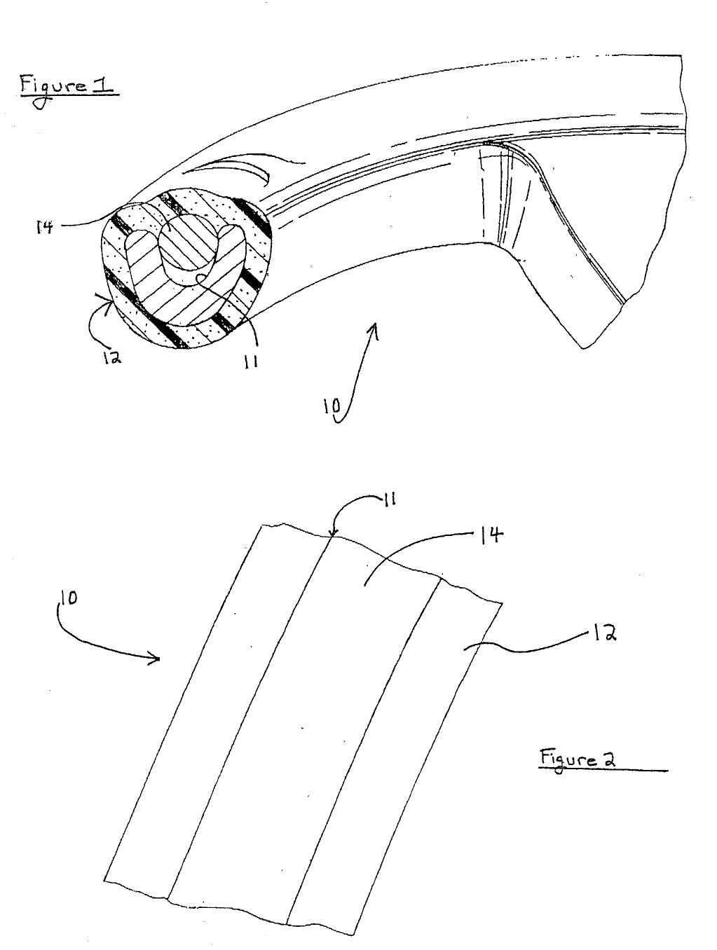

Referring to FIGS. 1 and 2, there are shown partial views of a steering wheel 10 according to a preferred embodiment of the present invention. Steering wheel 10 has a core with a substantially circular rim 12; preferably, a metallic machined or die cast rim, and preferably having a circumferential channel 11. A dampening element 14 is secured about rim 12 and is preferably positioned at least partially within channel 11, and secured therein. In a preferred embodiment, the steering wheel core is die cast aluminum or magnesium, and is formed as a unitary core member having a plurality of spokes (not shown) connecting rim 12 to a central body (not shown), and mounted to a vehicle steering system in a conventional manner. When fully assembled, steering wheel 10 is preferably covered with a known covering material, for example plastic, leather, or fabric. Securing dampening element 14, preferably formed of a relatively dense material, to rim 12 increases the moment of inertia of the steering wheel as well as the rotational mass moment of inertia, increasing its resistance to rotational vibration. It should be appreciated that actually providing a channel in rim 12 is not critical for purposes of the present invention, however, a channel helps in positioning and retaining the dampener weight, and thus represents a preferred embodiment. Those skilled in the art will appreciate that securing dampener 14 “about” rim 12 encompasses a wide variety of securing means, and it is not necessary that dampener 14 be actually attached to rim 12 itself.

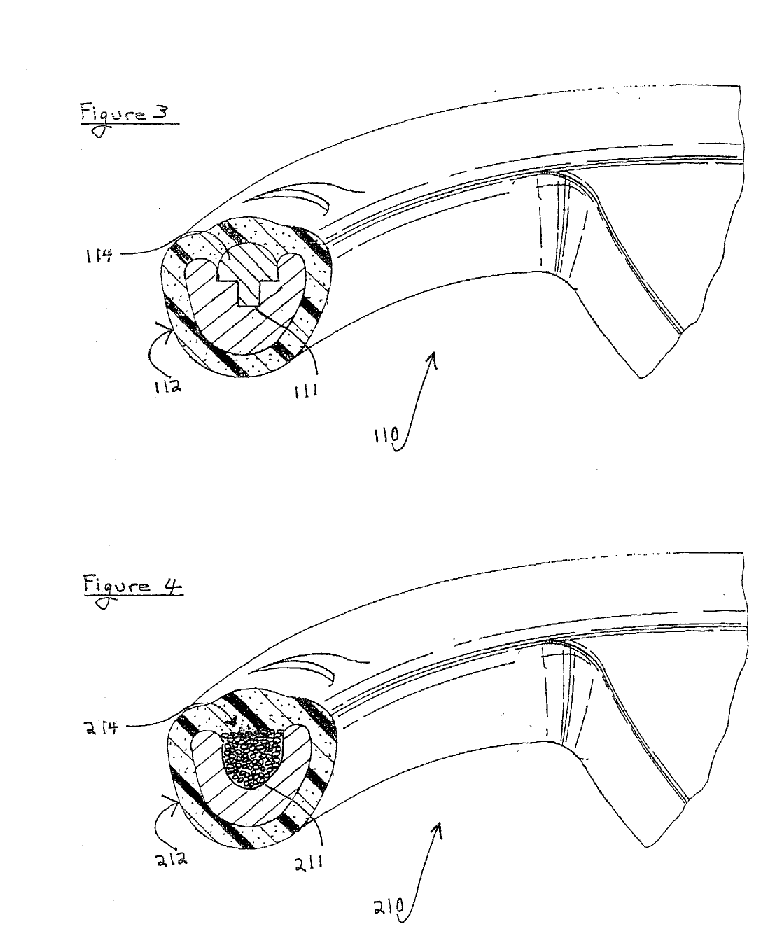

Channel 11 is preferably substantially U-shaped in cross-section, but might vary considerably without departing from the scope of the present invention. In a preferred embodiment, channel 11 is molded when casting the unitary core member, however, the channel might instead be machined. Alternatively, the entire rim 14 might be manufactured as a separate piece, and attached to spokes and a central mount portion to assemble the core member. Rather than a U-shaped channel, rim 12 might have, for example, a T-shaped, square, semi-circular, or V-shaped channel. FIG. 3 illustrates a T-shaped channel 111 mounted in a steering wheel 110. Returning to FIGS. 1 and 2, dampener 14 can similarly be formed having a variety of cross-sectional geometries, preferably designed to substantially match the cross section of channel 11, wherein dampener 14 is positioned. In a preferred embodiment, channel 11 is continuous around circular rim 12, however, it should be appreciated that rim 12 might have a plurality of channels, separated by filled-in regions, positioned circumferentially around rim 12. One preferred die casting process leaves portions of the channel filled wherein the die is gated for molten metal delivery. Dampener 14 is preferably a complete or partial ring made from a material denser than rim 12, for instance lead, steel, tungsten, or some other metal. The dampening element(s) may also be a sufficiently dense non-metallic material, for example, a dense polyvinyl chloride (PVC). Various designs are possible, and rather than a ring or partial ring, dampener 14 might instead comprise a plurality of pieces preferably positioned substantially symmetrically around steering wheel 10. Although the dampening element is preferably substantially radially symmetrical about the rim, alternative constructions are contemplated in which the mass may be asymmetrically oriented about the center of the wheel. In yet another embodiment, two partial circle members are utilized rather than a continuous ring. In this embodiment, the two distinct members can be positioned in channel 11, allowing the discontinuous dampener structure 14 to accommodate the solid regions resulting from the gates in the die. In the present description, dampener 14 is referred to in the singular, however, it should be appreciated that the descriptions herein are equally applicable to embodiments employing multiple dampeners. In still other contemplated embodiments, as illustrated in FIG. 4, a channel 211 is filled with a metallic powder or metal grindings/turnings 214 that can be pressed in the channel 211 to retain the material therein or, alternatively, heated and pressed to form dampening members that can be manipulated similar to dampener members/rings, as described above.

A variety of different methods of mounting dampener 14 about rim 12 are contemplated. In a preferred embodiment, dampener 14 is mounted substantially within channel 11; however, it might be mounted wholly or only partially within channel 11 depending on the dimensions of the dampener and the channel itself. Thus, as used herein, the term “within” will be understood to mean fully, as well as partially in the channel 11. Moreover, as described above, the use of a channel is not critical, and a weighted dampener member might be secured to the steering wheel rim by other means. For example, rather than a channel in the rim, the rim itself might be formed with a rounded outer surface matable with a channel in the dampener. Further, a channel type of interface is not necessary at all. The dampening element might, for instance, be formed with a flattened side that could be positioned flush with a flattened portion of the rim. The dampening element could be attached to the rim with fasteners, adhesive, or even spot welded. Various additional alternatives are possible, and those skilled in the art will appreciate that a great variety of different shaped rims and dampeners might be used without departing from the scope of the present invention. “Vibrational communication,” as used herein, will be understood to mean that vibrations are communicated between two structures. In a preferred mounting method, the rim 12 (and core member) with the inserted dampener 14 is positioned in an injection mold (not shown) with channel 11 facing upward. Next, a multiple-component elastomeric foaming material is delivered to the mold, in a process known in the art as reaction injection molding. The foam material, or adherent, is preferably a polyurethane foam or composite as known in the art, and adheres to dampener 14 and to rim 12, holding dampener 14 in its desired position and providing a resilient coating layer on the exterior of the wheel. The article may subsequently be painted, or covered with leather, plastic, etc. to finish the steering wheel. It should further be appreciated that dampener 14 is preferably formed from a material having a melting point sufficient to withstand the temperature during reaction injection molding, which generally ranges from 100° C. and above, and more specifically from 100° C. to 120° C. An illustrative example of a suitable injection molding method is described in U.S. Pat. No. 6,386,063 to Hayashi et al., herein incorporated by reference. Those skilled in the art will appreciate that a wide variety of known adhesives and elastomeric materials could be used as the steering wheel covering/dampener-retaining material without departing from the scope of the present invention.

Dampener 14 is thus secured in the channel by the foam, however, the preferably flexible, resilient nature of the foam can impart a degree of freedom of movement to dampener 14. Dampener 14 can be mounted in channel 11 such that the dampener piece(s) are in continuous contact with the rim 12, allowing translational and rotational vibrations from the core to be transmitted directly to the dampener. Alternatively, a layer of foam or other resilient material might be disposed between the dampener and the core, allowing the foam to absorb energy before transmitting the energy to the dampener. Such a design allows some of the energy of rotational vibration to be absorbed by expansion and contraction of the foam. Likewise, the use of resilient foam also increases resistance to translational vibration, expansion and contraction of the foam allowing the dampener to suppress non-rotational, i.e. linear vibrations. Other methods of affixing dampener 14 to the core member are contemplated, including mechanical attachment(s), such as rivets or screws, or tabs attached to rim 12 that can be bent over to secure dampener 14 in place. In an embodiment utilizing tabs to hold dampener 14 in place, the tabs may be formed integrally with rim 12 in a die casting process, or they may be attached separately after forming rim 12. Still other contemplated methods of affixing dampener 14 to rim 12 include press-fitting dampener 14 into channel 11, or crimping rim 12 to secure dampener 14 therein.

Adding weight around the rim of steering wheel 10 increases the polar mass moment of inertia of the wheel, increasing resistance to rotational vibration in the steering wheel. When mass is added at the exterior of the wheel, the rotational inertia of the wheel increases more than when an equal mass is added closer to the axis of rotation of the wheel (center body). The value of rotational inertia for a hoop rotated about a cylinder axis, similar to the rim of a steering wheel rotated about the steering column, can be expressed by the equation:

I=MR²

“I” is the rotational inertia, “M” is the mass of the rim (hoop), and “R” is the radius of the hoop. Although this expression only approximates the result of attaching the instant dampener 14 to the steering wheel, those skilled in the art will appreciate that rotational inertia generally increases with the square of the distance between the point where the mass is added and the axis of rotation. In many steering wheel designs, the actual axis of rotation is not at the exact center of the wheel, however, this mathematical relationship is generally applicable. Therefore, with greater rotational inertia, i.e. greater force required to initiate or reverse rotation of the steering wheel, the wheel has an increased resistance to rotational vibration. Because mass is added only where it has the most efficacious dampening effect, at the rim, the total mass that must be added to reduce vibration is minimized. By minimizing the required mass, the natural frequency of vibration of the steering wheel is not lowered as much as in systems that, for example, utilize a relatively larger mass, added closer to the center of the wheel. It has been a goal of designers to avoid constructing steering wheel systems with a natural vibration frequency close to natural frequencies encountered in operation of the vehicle as a whole, for instance that of the engine or the vehicle itself. As presently understood, the present invention allows a minimal amount of mass to be added, maintaining the natural frequency of vibration of the steering wheel at a value different from the vehicle or engine natural vibration frequencies, thereby minimizing undesirable resonance vibration of the steering wheel. Furthermore, avoiding the need to add an excessive amount of mass is less expensive and reduces the risk of significantly altering the crash performance of the steering system and related components, a problem that can arise where relatively large masses are added to the airbag module, or elsewhere close to the wheel's axis of rotation.

A problem related to rotational vibration involves the phenomenon known in the art as “lumpy return.” When a vehicle is directed into a turn, the steering wheel's subsequent return to its center position may take place through a series of jerky or bumpy motions rather than the desired smooth action. Adding mass to the wheel, particularly the addition of mass at the exterior, reduces the degree to which variations in the road surface, as well as fluctuations in the power steering operation, can reduce the smoothness of the wheel's return to its center position. Likewise, adding mass to the steering wheel as a whole increases the resistance of the wheel to translational, i.e. non-rotational vibrations.

In a related aspect, the present invention provides a tunable method of optimizing, e.g. increasing resistivity to, rotational vibration in a vehicle steering wheel. In different vehicle lines, and even in vehicles of the same make and model, subtle differences in components and production may cause optimal rotational vibration characteristics to vary. In a preferred embodiment, dampeners having various densities, sizes, configurations, and weights are made available for attachment to steering wheel 10. Simulation apparatuses, well known in the art, are used to simulate, for example, smooth road, bumpy road, and turning conditions encountered by a vehicle steering system. Thus, objective measurements of vibration amplitude and frequency can be recorded under varying simulated conditions. During testing, different rings or alternative dampening structures are inserted into the channel 11, giving the steering system greater or lesser resistance to rotational vibration, and greater or lesser natural vibration frequencies. In this fashion, the individual ring(s) or dampeners imparting vibration characteristics appropriate to a particular vehicle may be selected. A preferred testing sequence involves assembling a steering wheel apparatus without a dampening insert 14, then mounting the steering apparatus on the simulator to determine the vibration characteristics under different conditions. The next step, if necessary, involves mounting the heaviest of a plurality of available dampeners into the channel 11, then performing a second series of tests to determine the vibration characteristics with the weighted steering wheel. If satisfactory, the “heavy” dampener will be used for that vehicle, or line of vehicles. If unsatisfactory, the various other dampeners will be tested with the steering apparatus until the optimum dampener(s) is/are determined. A test rig for assessing rotational vibration characteristics of a steering wheel, and a method of doing so is described in Giacomin, J., Shayaa, M. S., Dormegnie, E. and Richard, L. 2001, A Frequency Weighting Curve For The Evaluation Of Steering Wheel Rotational Vibration, Submitted to the Journal of Sound and Vibration, and viewable on the internet at www.shef.ac.uk/mecheng/dynam/ra/human.htm. Other methods of determining the appropriate dampeners to insert into a particular steering wheel are contemplated, such as actual vehicle operation tests, and subjective data obtained from test drivers. For example, rather than the use of a simulation apparatus, drivers might operate a vehicle under different conditions and at different speeds, allowing experimenters to select the optimum dampener based on the stated preferences and experience of the test drivers. In some instances, the steering system may be fully assembled into the vehicle, with the exception of the dampener 14. Driving tests can be undertaken with various weighted rings and dampener designs held in the steering wheel, and a dampener permanently molded in place only after the optimum dampener is selected.

The present description is for illustrative purposes only, and should not be construed to limit the breadth of the present invention in any way. Thus, those skilled in the art will appreciate that various modifications might be made to the presently disclosed embodiments without departing from the spirit and scope of the invention, as defined in terms of the claims set forth below.

What is claimed:

1. A steering wheel for a motor vehicle comprising:
a core member having a given density, said core member having a substantially circular rim;
at least one dampening element secured about said rim; wherein
said dampening element is formed from a material having a density greater than the density of said core member, and is secured in vibrational communication with said core member.

2. The steering wheel of claim 1 wherein said circular rim defines a channel, and said dampening element is secured at least partially within said channel.

3. The steering wheel of claim 2 wherein said channel has a substantially U-shaped cross-section.

4. The steering wheel of claim 2 wherein said channel has a substantially T-shaped cross section.

5. The steering wheel of claim 1 wherein said dampening element is a substantially circular ring.

6. The steering wheel of claim 1 wherein said dampening element comprises a plurality of dampening elements positioned substantially radially symmetrically about said rim.

7. The steering wheel of claim 6 wherein said dampening element comprises a plurality of metal particles pressed into a channel defined by said rim.

8. The steering wheel of claim 1 wherein said dampening element is resiliently retained by an elastomeric material.

9. A method of manufacturing a steering wheel comprising the steps of:
providing a steering wheel core member having a circular rim section with a channel;
positioning at least one dampening element in the channel, the dampening element having a density greater than the core member;
positioning the core member and dampening element in a molding apparatus; and
delivering a flowable curable material into the molding apparatus, wherein the cured material adheres to the dampening element and the core member, and secures the dampening element in vibrational communication with the core member.

10. A method according to claim 9 wherein the step of positioning at least one dampening element in the channel includes positioning a plurality of dampening elements therein.

11. A method according to claim 9 wherein the step of positioning at least one dampening element in the channel is characterized by positioning the dampening element in continuous contact with the core member.

12. A method according to claim 9 wherein the step of positioning at least one dampening element in the channel is characterized by placing a resilient material between the dampening element and the core member.

13. A method according to claim 9 wherein the delivering step is characterized by injecting a plural component elastomeric material composition into the mold apparatus.

14. A method according to claim 9 wherein the delivering step is characterized by delivering an elastomeric material that is resilient when cured.

15. A steering wheel produced by the process of claim 9.

16. A method of optimizing rotational vibration in a vehicle steering wheel comprising the steps of:
forming a steering wheel core member having a substantially circular rim portion, the core member being connectable to a vehicle steering system; and
attaching mass to the core member by providing at least one dampening element, and securing it about the rim portion, the dampening element having a density greater than the density of the core member.

17. A method according to claim 16 wherein the attaching step is characterized by providing a metallic dampening element.

18. A method according to claim 16 wherein the attaching step is characterized by providing a non-metallic dampening element.

19. A method according to claim 16 wherein the attaching step is characterized by providing a plurality of dampening elements having different masses, selecting a first of the dampening elements having a first mass, and removably fastening the dampening element within the channel, the method further comprising the step of:
measuring rotational vibration of the core member with the first of the dampening elements fastened therein.

20. A method according to claim 20, further comprising the steps of:
removing the first of the dampening elements from the channel;
selecting a second of the dampening elements, the second dampening element having a second mass different from the mass of the first dampening element; and
measuring rotational vibration of the core member with the second of the dampening elements fastened therein.

21. A steering wheel formed according to a method comprising the method of claim 16.
